(19) United States
(12) Patent Application Publication
(10) Pub. No.: US 2006/0046718 A1
(43) Pub. Date: Mar. 2, 2006

(54) Presentation and management of aircraft availability data

(76) Inventor: Frederick Gevalt, Arlington, MA (US)

Correspondence Address: KIRKPATRICK & LOCKHART NICHOLSON GRAHAM LLP;(FORMERLY KIRKPATRICK & LOCKHART LLP), 75 STATE STREET, BOSTON, MA, 02109-1808, US

(21) Appl. No.: 10/926,725

(22) Filed: Aug. 26, 2004

(51) Int. Cl. H04Q 7/20

(52) U.S. Cl. 455/432.3

(57) ABSTRACT

A method for facilitating communication between a plurality of fixed base operators and a plurality of charter operators, including receiving a fixed base operator profile from a remote fixed base operator; querying a plurality of aircraft availability data based on the fixed base operator profile to obtain an opportunity; and notifying the fixed base operator if the opportunity matches the fixed base operator profile.

### SUMMARY OF THE INVENTION

An embodiment of the present invention relates to a method for facilitating communication between a plurality of fixed base operators and a plurality of charter operators, including receiving a fixed base operator profile from a remote fixed base operator; querying a plurality of aircraft availability data based on the fixed base operator profile to obtain an opportunity; and notifying the fixed base operator if the opportunity matches the fixed base operator profile.

### DESCRIPTION OF THE FIGURES

For the present invention to be understood clearly and readily practiced, the present invention will be described in conjunction with the following figures, wherein:

FIG. 1 is an exemplary system that provides a suitable operating environment for an embodiment of the present invention;

FIG. 2 is a block diagram illustrating a notification system in accordance with an embodiment of the present invention; and

FIG. 3 is a sequence diagram that illustrates an exemplary method for managing communication between a fixed base operator and a charter operator according to an embodiment of the present invention.

### DESCRIPTION

An embodiment of the present invention relates to a system for managing communications between a fixed base operator (FBO) and a charter aircraft operator. For example, an embodiment of the present invention may be useful to notify an FBO of an opportunity to market its services to a charter aircraft operator in advance of a charter trip destined for the FBO's geographic locale.

In the following discussion of an illustrative embodiment, the term “database,” as used herein, may be any body of information that is logically organized so that it can be retrieved, stored and searched in a coherent manner. The term “notification,” as used herein, broadly refers to a message received and understood that reduces the recipient's uncertainty. The term “data,” as used herein, broadly refers to a collection of facts from which conclusions may be drawn. The term “match,” as used herein, refers to a condition in which two items are of the same measure, quantity, amount, or number as another or others or within some predetermined tolerance. The term “profile,” as used herein, refers to a record of user-specific data that define the user's notification preferences.

Other terms used in the discussion of the illustrative embodiment include “availability data,” “transient availability data,” “scheduling data,” and “opportunity.” The terms “aircraft availability data” and “availability data” are used interchangeably throughout to broadly refer to data regarding particular aircraft available for hire on particular dates at particular locations. The term “transient availability data,” as used herein, refers to data about the availability of a particular aircraft for hire on a date or dates at a particular location other than its home base (a “distant location”). “Scheduling data,” as used herein, refers to data about particular aircraft that have been hired to operate on particular dates between particular locations. An “opportunity,” as used herein, refers to advance information about a particular aircraft that will be traveling to a distant location. Such information may include, for example, a date, airport, aircraft type and operator. According to an embodiment, an opportunity may be identified directly from scheduling data or inferred from transient availability data. Those of ordinary skill in the art will appreciate that an opportunity for an FBO to market its services arises when an aircraft is at a distant location.

It is to be understood that the figures and descriptions of the present invention have been simplified to illustrate elements that are relevant for a clear understanding of the present invention while eliminating, for purposes of clarity, other elements. For example, certain details relating to the specifications of protocols for use in transporting notifications and availability data over a network and certain details of suitable algorithms for processing queries of availability data are not described herein. Those of ordinary skill in the art will recognize, however, that these and other elements may be desirable in a notification system. A discussion of such elements is not provided because such elements are well known in the art and because they do not facilitate a better understanding of the present invention.

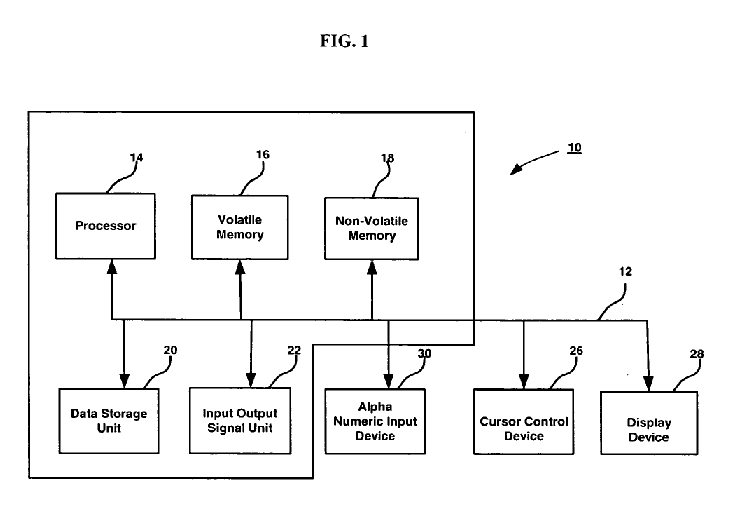

FIG. 1 is a block diagram that illustrates various hardware components of an information processing system 10 used as a part of a notification system in accordance with an embodiment of the present invention. System 10 includes a system bus 12 for conveying information between the various components, a processor 14 for processing the information and instructions, a memory comprised of volatile random access memory (RAM) 16, and a non-volatile read only memory (ROM) 18. System 10 can optionally include, for example, a data storage unit 20, e.g., a magnetic, optical, floppy, or tape drive, for storing vast amounts of data, and an input/output interface or signal unit 22 for interfacing with peripheral devices, e.g., a computer network, a modem, mass storage devices, etc. Devices that may be coupled to computer system 10 include, for example, a display device 28 for displaying information to a computer user, an alphanumeric input device 30, e.g., a keyboard, and a cursor control device 26 (e.g., mouse, trackball, light pen, etc.) for inputting data, selections, updates, etc. In that regard, information processing system 10 may be any network-enabled device such as, for example, a personal computer, a personal digital assistant (PDA), a workstation, a laptop computer, a handheld computing device, or combination thereof.

These are representative components of an information processing system whose operation is well understood. Furthermore, those of ordinary skill in the art will appreciate that system 10 of FIG. 1 is exemplary only and that the present invention can operate within a number of different computer systems including general-purpose computer systems, embedded computer systems, and stand-alone computer systems specially adapted for applications relating to data processing or a distributed computing network.

System 10 may also include a computer readable medium having executable instructions or data fields stored thereon, such as data storage unit 20. The computer readable medium can be any available medium that can be accessed by a general purpose or special purpose computer. By way of example, and not limitation, such a computer readable medium can comprise RAM, ROM, electrically erasable programmable read only memory (EEPROM), CD-ROM or other optical disk storage, magnetic disk storage or other magnetic storage devices, or any other medium that can be used to store desired executable instructions or data fields and that can be accessed by a general purpose or a special purpose computer.

The computer readable medium tangibly embodies a program, functions, and/or instructions that cause the computer system to operate in a specific and predefined manner as described herein. Those skilled in the art will appreciate, however, that the process described below may be implemented at any level, ranging from hardware to application software and in any appropriate physical location. For example, the present invention may be implemented as software code to be executed by system 10 using any suitable computer language and may be stored on any of the storage media described above, or can be configured into the logic of system 10. Such software code may be executed by system 10 using any suitable computer language such as, for example, Java, Javascript, C++, C, C#, Perl, Visual Basic, Transact/Structure Query Language (T/SQL), database languages, APIs, various system-level SDKs, assembly, firmware, microcode, and/or other languages and tools.

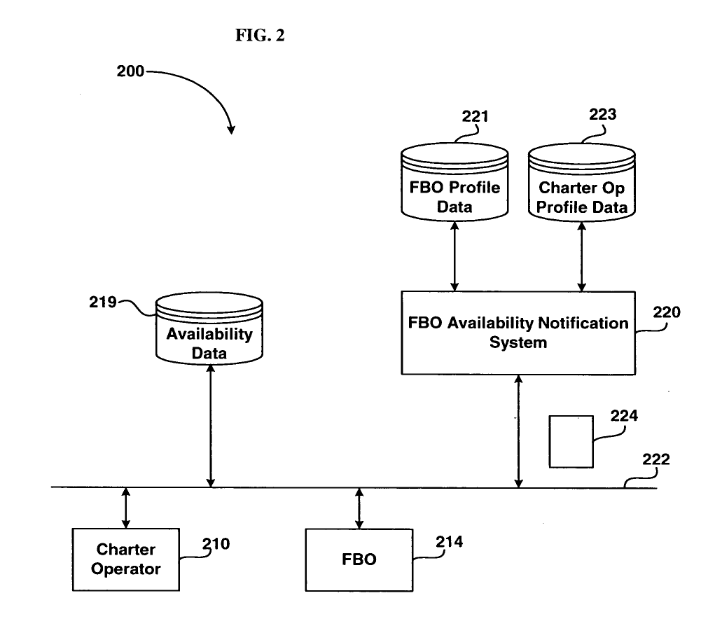

FIG. 2 is an exemplary block diagram that illustrates a system 200 according to an embodiment of the present invention. As shown, system 200 includes a charter operator 210, an FBO 214, an availability database 219, an FBO profile database 221, a charter operator profile database 223, and an FBO availability notification system 220, communicating over a network 222. Although system 200 includes a single charter operator and a single FBO, those of ordinary skill in the art will understand that such a system may include additional charter operators and FBOs communicating with notification system 220.

Charter operator 210 refers to an operator of aircraft for hire on a flight-by-flight basis, such as those operating under Part 135 of the Federal Aviation Regulations.

FBO 214 refers to an airport-based provider of goods and services to aircraft and aircraft operators.

Availability database 219 may be a compilation of transient aircraft availability data. According to an embodiment, transient aircraft availability data is input into a database by a charter operator, such as charter operator 210. For example, charter operator 210 may indicate in availability database 219 that its Gulfstream V will be at a distant location, such as St. Louis, Mo., from August 9^{th} through August 12^{th}. Such transient availability data may be used, for example, to infer the date on which the aircraft would be traveling from its home base to the distant location. If a St. Louis-based FBO, such as FBO 214, receives this information in advance of August 9^{th}, such as via system 200, it is then in a position to market its services to charter operator 210 before the Gulfstream V departs for St. Louis. According to an embodiment, availability database 219 may be implemented using the CharterX® availability database available from CharterX, Inc. of Newtown, Pa.

According to another embodiment, availability database 219 may include scheduling data. Scheduling data may include data that indicates, for example, that charter operator 210 has been hired and is scheduled to fly its Gulfstream V from Bedford, Mass. to St. Louis, Mo. on August 9^{th} and to return from St. Louis to Bedford on August 12^{th}. Availability database 219 may include transient availability data, scheduling data, or a combination of scheduling data and transient availability data. Those of ordinary skill in the art will appreciate that scheduling data may be inferred from transient availability data.

FBO profile database 221 may be a compilation of FBO-specific information relating to availability notifications. According to an embodiment, database 221 includes a notification profile for each participating FBO. Database 221 may include, for example, the FBO's locations and contact information for FBO representatives designated to receive notifications, such as an email address.

Charter operator profile database 223 may be a compilation of operator-specific information relating to availability notifications. According to an embodiment, charter operator profile database 223 includes a notification profile for each participating charter operator. Database 221 may include, for example, the charter operator's contact information for representatives designated to receive notifications from FBOs, such as an email address. Those of ordinary skill in the art will understand that FBO profile database 221 and charter operator profile database 223 may be implemented as stand-alone databases or integrated into FBO availability notification system 220.

FBO availability notification system 220 may be configured to manage communications between charter operators and FBOs. According to an embodiment, notification system 220 may be used to send, for example, notification 224 to FBO 214 that charter operator 210 has transient availability at an airport where FBO 214 operates. In this regard, notification 224 provides FBO 214 with the opportunity to market its services to charter operator 210. FBO availability notification system 220 is described in greater detail below.

In the illustrated embodiment, communication may be over any suitable computer network including, for example, metropolitan area networks (MAN) and/or various “Internet” or IP networks such as the World Wide Web, a private Internet, a secure Internet, a value-added network, a virtual private network, an extranet, or an intranet. Other suitable networks may contain other combinations of servers, clients, and/or peer-to-peer nodes. The invention may also be practiced in distributed computing environments where tasks are performed by remote processing devices that are linked through a communications network. In a distributed computing environment, program modules may be located in both local and remote memory storage devices.

Communication may be made by exchanging data packets according to a predefined set of protocols, such as the Transmission Control Protocol/Internet Protocol (TCP/IP). Those of ordinary skill will appreciate that other techniques or protocols may be suitable for use with the present invention. According to an embodiment, HTTP or any of several other standard protocols may be used to exchange information, which could then be formatted for display. According to other embodiments, communication may be accomplished wirelessly through, for example, PCS, cellular, Bluetooth, 802.11, WiFi, Infrared, radio frequency, or other wireless technology.

In operation, according to an embodiment, notification system 220 queries availability database 219 to identify transient availability data or scheduling data that matches FBO notification profile 221 for FBO 214. If notification profile 221 for FBO 214 matches a flight operated by charter operator 210, and charter operator 210 has an active and matching profile 223, FBO availability notification module 220 contacts FBO 214, such as by sending a notification 224, and invites FBO 214 to contact charter operator 210.

According to an embodiment, notification 224 may be an email message from notification system 220 including, for example, the opportunity type, airports and dates, the type of aircraft, and an aircraft identifier. Upon receipt of notification 224, FBO 214 may send a marketing message to charter operator 210, inviting charter operator 210 to respond to FBO 214 and, if appropriate, engage FBO 214 to service the aircraft. Notification 224 may also include, for example, an embedded hyperlink that connects to a web page for entering a customized marketing message to charter operator 210. According to other embodiments, notification 224 may be a telephone call.

FIGS. 1 and 2 and the foregoing discussion are intended to provide a brief, general description of a suitable computing environment in which the invention may be implemented. Although not required, the invention is described herein in the general context of computer-executable instructions, such as program modules, being executed by a computer. Thus, the hardware and software configurations depicted in FIGS. 1 and 2 are intended merely to show a representative configuration. Accordingly, it should be understood that the invention encompasses other computer system hardware configurations and is not limited to the specific hardware and software configurations described above. It should also be understood that the input data may be entered manually, be derived from a data source, or be obtained from a combination of manual and automated input. In that regard, communications may be accomplished using any combination of manual and automatic means including a telephone network or by mail.

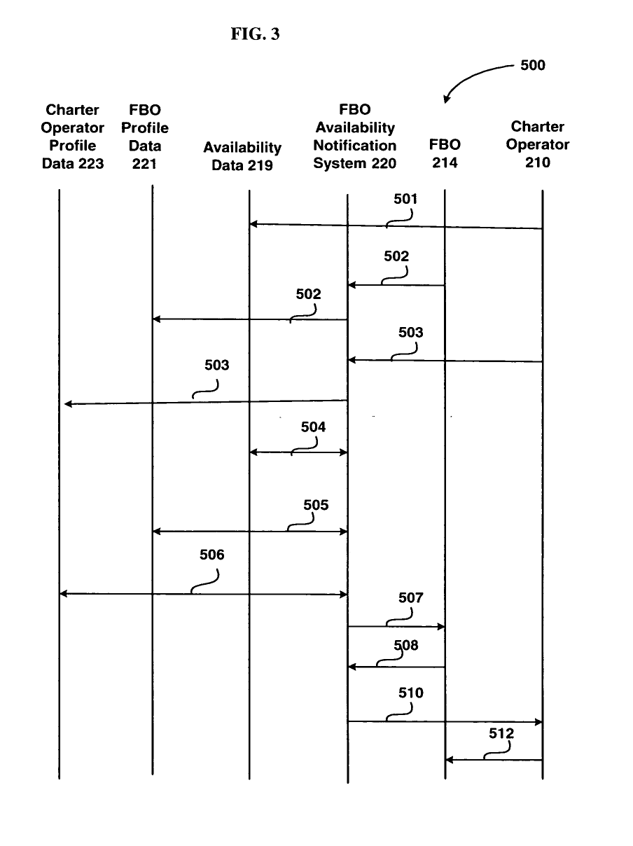

FIG. 3 is a sequence diagram that illustrates an exemplary method 500 for facilitating communication between FBO 214 and charter operator 210. Method 500 begins in step 501 when, for example, operator 210 enters transient availability data into availability database 219. Referring again to the example described above, charter operator 210 may indicate in step 501 that its Gulfstream V will be in St. Louis, Mo. from August 9^{th} at 7:00 pm through August 12^{th} at 7:00 am. This example illustrates an opportunity 230 (not shown) for St. Louis-based FBO 214 to offer its services to charter operator 210.

In step 502, FBO 214 communicates its profile to notification module 220 which, in turn, may be stored in FBO profile database 221. Similarly, in step 503, charter operator 210 communicates its profile to notification module 220 which, in turn, may be stored in charter operator profile database 223.

In step 504, according to an embodiment, notification system 220 queries availability database 219, such as for a city or airport. A query for “St. Louis” may identify, for example, opportunity 230 as described above.

In step 505, notification system 220 queries FBO notification profile database 221 to determine which FBOs should receive notifications 224 about opportunity 230. According to an embodiment, a “match” may occur if an airport associated with opportunity 230 is specified in FBO profile 221. Notification system 220 may learn, for example, that only FBO 214 requested notifications of availability in St. Louis. Next, in step 506, notification system 220 queries charter operator profile database 223 to determine whether charter operator 210 has an active profile and, if so, whether opportunity 230 matches charter operator 210's notification profile in database 223. If profile 223 matches, notification module 220 sends notification 224 to FBO 214 in step 507. Those of ordinary skill in the art will understand that notification module 220 may contemporaneously notify any other FBO that has an active profile matching a given opportunity. According to such an embodiment, charter operator 210 may receive multiple offers in connection with opportunity 230. Those of ordinary skill in the art will also appreciate that steps 504, 505, and 506 may be carried out in any order.

According to an embodiment, notification module 220 may be configured to maintain a list of sent notifications, for example, to prevent FBO 214 from receiving duplicate notifications of opportunity 230. Those of ordinary skill will appreciate that such an embodiment may be useful if the charter operator uses an extractor, which can repeatedly re-write the operator's schedule every few minutes.

In step 508, a user at FBO 214 clicks on a hyperlink embedded in notification 224 and connects, for example, to a web page for entering a customized marketing message 232 (not shown) to operator 210. Marketing message 232 may include, for example, contact information for FBO 214 and a special marketing offer. According to an embodiment, notification module 220 may be configured to uniquely identify each notification 224. Those of ordinary skill will appreciate that this embodiment may be useful to limit the number of responses FBO 214 can send to charter operator 210 in connection with notification 224 and opportunity 230.

In step 510, notification module 220 receives marketing message 232 and forwards it to charter operator 210. If interested, operator 210 will contact FBO directly in step 512 using, for example, contact information supplied in marketing message 232. Those of ordinary skill in the art will appreciate that charter operator 210 could contact FBO 214 via notification system 200.

While the foregoing has been with reference to a few specific embodiments of the invention, it will be appreciated by those skilled in the art that changes in these embodiments may be made without departing from the principles and spirit of the invention, the scope of which is defined by the appended claims.

What is claimed is:

1. A method performed by a computer for facilitating communication over a network between a plurality of fixed base operator computers and a plurality of charter operator computers, comprising:
receiving a fixed base operator profile from a remote fixed base operator computer;
querying a database based on the fixed base operator profile to obtain a result;
presenting a marketing message web page to the remote fixed base operator computer if the result matches the fixed base operator profile;
receiving the marketing message web page from the remote fixed base operator computer; and
communicating the marketing message web page to a remote charter operator computer.

2. The method of claim 1 further comprising
receiving a charter operator profile from a remote charter operator computer and wherein the communicating step includes communicating the marketing message web page to the remote charter operator computer if the result matches the charter operator profile.

3. The method of claim 1 wherein the database includes a plurality of aircraft availability data.

4. The method of claim 1 wherein the fixed base operator profile includes an airport.

5. The method of claim 1 wherein presenting includes sending an email message to the remote fixed base operator computer with a link to the marketing message web page.

6. A method for facilitating communication between a plurality of fixed base operators and a plurality of charter operators, comprising:
receiving a fixed base operator profile from a remote fixed base operator;
querying a plurality of aircraft availability data based on the fixed base operator profile to obtain an opportunity; and
notifying the fixed base operator if the opportunity matches the fixed base operator profile.

7. The method of claim 6 further comprising
inferring the opportunity from transient aircraft availability data.

8. The method of claim 6 wherein querying includes querying a plurality of scheduling data.

9. The method of claim 6 further comprising
receiving a marketing message from the remote fixed base operator; and
communicating the marketing message to the charter operator.

10. The method of claim 6 further comprising
receiving a charter operator profile from a remote charter operator; and
wherein the communicating step occurs if the opportunity matches the charter operator profile.

11. A computer storage medium having stored thereon the opportunity produced according to the method of claim 6.

12. A computer storage medium having stored thereon instructions causing a computer to perform the method of claim 6.

13. A notification received by a fixed base operator comprising:
an identifier for a charter operator; and
a plurality of transient availability data with respect to an aircraft, the aircraft being operated in connection with the charter operator.

14. A network comprising:
a database for storing aircraft availability data;
a fixed base operator computer;
a charter operator computer; and
a notification module in communication with the charter operator computer and the fixed base operator computer, the notification module being configured to:
receive aircraft availability data from the database; and
communicate a notification to the fixed base operator computer if the database contains a record that matches a fixed base operator profile.

15. A system for facilitating communication between a plurality of fixed base operator computers and a plurality of charter operator computers, comprising:
a database for storing aircraft availability data; and
a notification module in communication with the database and a fixed base operator for communicating aircraft availability data to the fixed base operator based on a profile.

16. The system of claim 15 wherein the profile includes at least one airport.

17. The system of claim 15 wherein the notification module is automatic.

18. A method for facilitating communication between a plurality of fixed base operators and a plurality of charter operators, comprising:
receiving a fixed base operator profile from a remote fixed base operator;
querying a plurality of scheduling data based on the fixed base operator profile to obtain an opportunity; and
notifying the fixed base operator if the opportunity matches the fixed base operator profile.
